(19) United States
(12) Patent Application Publication
(10) Pub. No.: US 2013/0051933 A1
(43) Pub. Date: Feb. 28, 2013

(54) PUMPING COARSE ORE

(71) Applicant: Carly Louise Painter, Perth (AU)

(72) Inventor: Carly Louise Painter, Perth (AU)

(21) Appl. No.: 13/636,503

(22) PCT Filed: Mar. 24, 2011
(86) PCT No.: PCT/AU11/00336

§ 371 Date: Nov. 6, 2012

(30) Foreign Application Priority Data
Mar. 24, 2010 (AU) 2010901250

(51) Int. Cl. E21C 47/00; B65G 53/00

(52) U.S. Cl. 406/96; 406/197

(57) ABSTRACT

A method and an apparatus for pumping a mined material in the form of a coarse ore is disclosed. The method comprises suspending particles of the coarse ore in a non-Newtonian fluid and thereby forming a slurry of the coarse ore particles in the fluid. The method also comprises transferring the slurry, for example by pumping the slurry, in a pipeline.

The present invention relates to pumping a mined material in the form of a coarse ore.

The present invention relates particularly, although by no means exclusively, to pumping a mined material that has a specific gravity of greater than 1.2 and a particle size greater than 1 mm in a slurry with a solids concentration greater than 30% by volume. Iron ore is one example of such a mined material.

It is known to transport mined material, such as coal, bauxite and iron ore, in a slurry form in pipelines. However, the known technology is limited to transporting fine particles that are less than 1 mm in diameter, generally less than 0.6 mm, in low concentrations (i.e. less than 40% by volume) and requiring high levels of turbulence and high velocities to maintain the particles in suspension.

The above description is not to be taken as a statement of the common general knowledge in Australia or elsewhere.

The present invention transports coarse particles of a mined material in a non-Newtonian fluid in a pipeline. The coarse ore particles are suspended in the non-Newtonian fluid.

According to the present invention there is provided a method of pumping a mined material in the form of a coarse ore that comprises:
(a) suspending particles of the coarse ore in a non-Newtonian fluid and thereby forming a slurry of the coarse ore particles in the fluid, and
(b) transferring the slurry, for example by pumping the slurry, in a pipeline.

The term “non-Newtonian fluid” is understood herein to mean a fluid whose rheological behaviour cannot be described on the basis of the Navier-Stokes equations.

Pages 15 and 16 of Barnes H. A., Hutton J. F. and Walters K. “Introduction to Rheology”, Elsevier publishing, third impression, 1993, explains that Newtonian fluids have the following characteristics in experiments conducted at constant temperature and pressure and that any fluid that does not have these characteristics is a non-Newtonian fluid:
(a) The only stress generated in simple shear flow is the shear stress a, the two normal stress differences being zero.
(b) The shear viscosity does not vary with shear rate.
(c) The viscosity is constant with respect to the time of shearing and the stress in the liquid falls to zero immediately the shearing is stopped. In any subsequent shearing, however long the period of resting between measurements, the viscosity is as previously measured.
(d) The viscosities measured in different types of deformation are always in simple proportion to one another, so, for example, the viscosity measured in a uniaxial extensional flow is always three times the value measured in simple shear flow.
   A liquid showing any deviation from the above behaviour is non-Newtonian.”

The term “coarse ore particles” is understood herein to mean ore particles that are too large and too massive to form a part of the non-Newtonian fluid of the slurry.

The coarse ore may be any mined material, including but not limited to iron ore.

The coarse ore may have particle sizes greater than 1 mm.

The coarse ore may have particle sizes greater than 2 mm.

Particularly in situations where the coarse ore is an iron ore, the coarse ore may have particle sizes greater than 6 mm.

Preferably a shear yield stress of the non-Newtonian fluid is sufficient to suspend the largest particles in the coarse ore particles in the non-Newtonian fluid.

The non-Newtonian fluid may comprise a slurry of ultra-fine particles or slimes in water.

The ultra-fine particles may have particle sizes below 0.5 mm.

The ultra-fine particles or slimes may be from the same ore as the coarse ore particles or may be a different material.

For example, the non-Newtonian fluid may be a mine tailings from the same mine as the coarse ore particles.

Typically, the minimum shear yield stress τ_{y} required to support iron ore particles is in a range of 20-40 Pa in a case of slurries formed from coarse iron ore particles having a top size of 70 mm and a non-Newtonian fluid comprising ultrafine particles of iron ore in water, with the iron ore having a specific gravity in a range of 4-4.3, the solids concentration in the non-Newtonian fluid being in a range of 10-60% by volume, and the coarse ore particles being 20-40% by volume of the slurry.

The method may comprise mining ore in a mine, crushing the mined ore in a mine pit and thereby forming the coarse ore particles in the mine pit, and forming the slurry from the coarse ore particles in the mine pit.

The method may comprise mining ore in a mine, primary crushing the mined ore in a mine pit, secondary and optionally tertiary crushing the primary crushed ore and thereby forming the coarse ore particles in the mine pit, and forming the slurry from the coarse ore particles in the mine pit.

The method may comprise pumping the slurry from the mine pit up a pit wall.

The pit wall may be at least 30-50 m high. The pit wall may be at least 100 m high.

The pit wall may be at least 200 m high.

The pit wall may have an angle of inclination of at least 30° to a horizontal axis.

The pit wall may have an angle of inclination of at least 40° to a horizontal axis.

The method may comprise pumping the slurry from the mine pit up the pit wall and to a location proximate the pit or at least several kilometres from the pit.

The method may comprise pumping the slurry to a wet upgrading plant and separating the coarse ore particles from the non-Newtonian fluid.

The method may comprise using the separated non-Newtonian fluid in step (a) of the method and forming the slurry.

The method may comprise using the separated non-Newtonian fluid in step (a) of the method and another supply of non-Newtonian fluid and forming the slurry.

The method may comprise using the separated non-Newtonian fluid in the method, with or without another supply of non-Newtonian fluid, and forming the slurry and using the pressure of the separated non-Newtonian fluid to contribute at least partly to the pressure required to transfer the slurry in the pipeline. By way of example, non-Newtonian fluid that is separated from the slurry after the slurry has been pumped up a pit wall and that is then returned to the pit as separated non-Newtonian fluid will have pressure derived from the static head and any additional head imparted by a pump outside the pit and, if this fluid is used to form the slurry, this pressure can contribute to transferring the slurry up the pit wall.

The primary crushing step may reduce the mined ore to a particle size of less than 350 mm.

Step (a) of the method may comprise forming the slurry with a concentration of at least 30% by volume coarse ore particles.

The concentration may be at least 40% by volume.

The concentration may be at least 45% by volume.

Step (a) of the method may comprise forming the slurry with a concentration of at least 40% by weight coarse ore particles.

The concentration may be at least 50% by weight coarse ore particles.

The concentration may be at least 60% by weight coarse ore particles.

Step (b) of the method may comprise transferring the slurry at a velocity of less than 5 m/s.

Step (b) of the method may comprise transferring the slurry at a velocity of less than 3 m/s.

Step (b) of the method may comprise transferring the slurry under turbulent conditions or laminar conditions.

Step (b) of the method may comprise transferring the slurry by pumping the slurry.

The ore may have a specific gravity of greater than 1.2.

The ore may have a specific gravity of greater than 1.5.

The ore may have a specific gravity of greater than 3.0.

According to the present invention there is provided an apparatus for pumping a mined material in the form of a coarse ore that comprises:
(a) a plant for forming a slurry of coarse ore particles and a non-Newtonian fluid;
(b) a pipeline for transporting the slurry from the slurry plant; and
(c) at least one pump for pumping the slurry along the pipeline.

The apparatus may comprise a wet upgrading plant for separating the coarse ore particles from the non-Newtonian fluid.

The slurry plant may be located in a mine pit.

The pipeline may comprise a section that extends along the floor of the pit and a section that extends up a wall of the pit.

The pipeline may comprise a section that extends at least several kilometres away from the pit.

The pit wall may be at least 30-50 m high.

The pit wall may be at least 100 m high.

The pit wall may be at least 200 m high.

The pit wall may have an angle of inclination of at least 30° to a horizontal axis.

The pit wall may have an angle of inclination of at least 40° to a horizontal axis.

The slurry plant may be a mobile or semi-mobile plant.

The slurry plant may comprise primary and secondary and optionally tertiary crushers for crushing run-of-mine ore to form coarse ore particles and a paste mixer assembly for forming the slurry.

The pump may be any suitable pump.

The present invention is described further by way of example with reference to the accompanying drawings, of which:

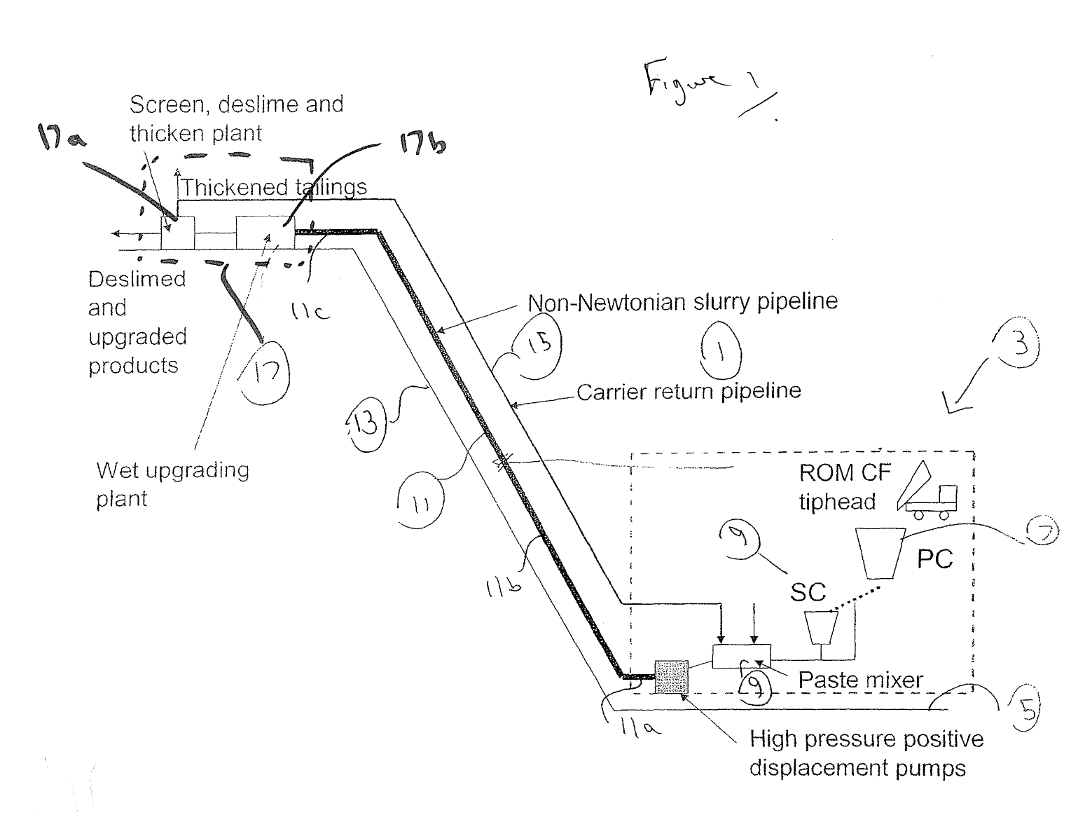

FIG. 1 is a schematic diagram of one embodiment of a method and an apparatus for pumping coarse particles of iron ore in a pipeline from a mine pit in accordance with the present invention; and

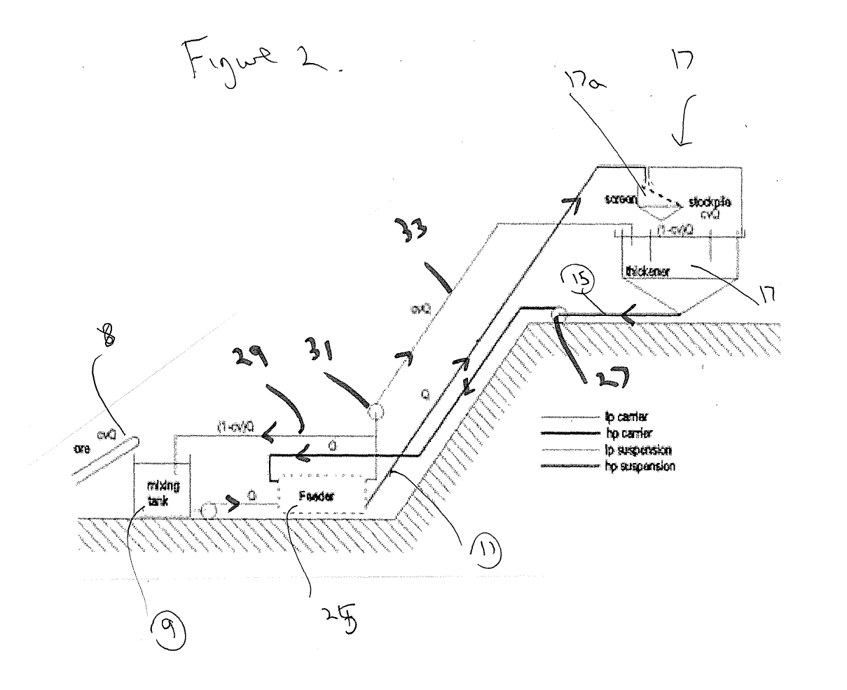

FIG. 2 is a schematic diagram of another, although not the only other possible, embodiment of a method and an apparatus for pumping coarse particles of iron ore in a pipeline from a mine pit in accordance with the present invention.

With reference to FIG. 1, mined iron ore is transported, for example via trucks, to a mobile slurry plant 3 within a mine pit 1 and is processed in the plant to form a slurry of coarse iron ore particles and a non-Newtonian fluid to be pumped in a pipeline 11. In the slurry plant 3 the mined ore is subjected to primary crushing in a primary crusher 7 and the crushed ore is then subjected to further crushing in a secondary crusher 9.

The resultant coarse ore particles, which typically have a P90 with a particle size of at least 6 mm, are supplied to a paste mixer 9 in the slurry plant 3 and are mixed with a non-Newtonian fluid to form the slurry. Typically, the concentration of the coarse ore particles in the slurry is as high as possible in terms of being able to be pumped efficiently through the pipeline 11 and to minimise the extent of dewatering that is required at the end of the pipeline 11.

In the embodiment shown in the figure, the non-Newtonian fluid is in the form of a mine tailings that has been thickened with additional ultrafine ore particles to form the non-Newtonian fluid.

The slurry formed in the paste mixer 9 is pumped along the pipeline 11 by means of a pump 13 positioned in the mine pit 1. Depending on the length of the pipeline 11, there may be one or more than one additional pump (not shown) located along the line.

The pipeline 11 comprises a section 11a that extends along a section of the pit floor 5, a section 11b that extends up a side wall 13 of the pit (which may be at least 30-50 m, typically at least 100 m high, and at an angle of at least 30° to a horizontal axis), and a further section 11c that extends along the ground outside the pit. The lengths of the pipeline sections 11a, 11b, 11c shown in the figure are not intended to represent relative lengths of the sections. The pipeline sections, and the overall length of the pipeline 11, may be any suitable length.

The slurry is transported via the pipeline 11 to a wet upgrading plant 17, which comprises screens 17a and a thickener 17b, outside the pit 1 and the coarse ore particles are separated from the non-Newtonian fluid and are processed as required. The separated non-Newtonian fluid, i.e. the underflow from the thickener 17b, is returned via a pipeline 15 to the paste mixer 9.

The embodiment of the method and the apparatus for pumping coarse ore particles shown in FIG. 2 is similar in many important respects to the embodiment shown in FIG. 1. The main differences between the two embodiments are that the process/apparatus disclosed in FIG. 2 (a) uses the static head of a stream of a non-Newtonian fluid that is produced outside a pit and is transferred into the pit and the extra head imparted by a pump that contributes to transferring the stream into the pit to provide high pressure to carry a coarse ore slurry from a feed tank up the pit wall and (b) includes a low pressure return line from the feed tank that splits into one stream that is transferred to a slurry mixing tank and a second stream that is pumped up the pit wall to a wet upgrading plant that separates the slurry into coarse ore particles and the non-Newtonian fluid stream mentioned above.

With reference to FIG. 2, mined iron ore that has been subjected to primary and secondary crushing and, typically, has a P90 with a particle size of at least 6 mm, is supplied via a belt conveyor 6 to a mixing tank 9 located in the mine pit and is mixed with a stream of a recycle slurry to form a coarse ore particle slurry.

The slurry formed in the mixing tank 9 is pumped to a feed tank 25 and is mixed with a pressurised stream of underflow from a thickener 17b that is located outside the pit and forms a required slurry of coarse ore particles in the feed tank 25. The thickener underflow is predominantly a non-Newtonian fluid and is supplied to the feed tank 25 via a pipeline 15. The thickener 17b and a screen 17a form part of a wet upgrading plant 17 located outside the pit that separates coarse ore slurry from the pit into coarse ore particles and the thickener underflow.

The slurry of coarse ore particles in the feed tank 25 flows from the feed tank 25 up the pit wall in the pipeline 11. Typically, the angle of the pit wall is at least 30° to a horizontal axis and the length of the pipeline 11 is of the order of 150-200 m.

The amounts and concentrations of the slurry from the mixing tank 9 and the thickener underflow supplied via the pipeline 15 and the pressure of the thickener underflow are controlled to provide (a) a required concentration of coarse ore particles in the slurry and (b) a required pressure to transfer the slurry through the pipeline 11 from the feed tank 25 up the pit wall. Typically, the concentration of the coarse ore particles in the slurry is as high as possible in terms of being able to be transferred efficiently through the pipeline 11 and to minimise the extent of dewatering that is required at the end of the pipeline 11.

The slurry is transported via the pipeline 11 to the above-mentioned wet upgrading plant 17 outside the pit and the coarse ore particles are separated from the non-Newtonian fluid and are processed as required. The separated non-Newtonian fluid is returned, as described above, via the pipeline 15 to the feed tank 25. A pump 27 facilitates transfer of the thickener underflow to the feed tank 25. Basically, the pressure of the thickener underflow stream comprises the static head between the pit floor and the thickener 17b outside the pit and the head provided by the pump 27, which may be adjusted as required.

In addition, a low pressure stream of the slurry from the feed tank 25 is split into two streams, with one stream being transferred in a pipeline 29 to the slurry mixing tank 9 and forming the slurry with the incoming coarse ore particles and a second stream being pumped via a pump 31 and in a pipeline 33 to the thickener 17b of the wet upgrading plant 17.

The present invention is based on research work carried out by the applicant.

The purpose of the research work was to investigate the feasibility and subsequent conceptual design of a coarse ore pumping method and apparatus in accordance with the invention. The research work included investigating whether coarse ore could be pumped to the surface of a mine pit using conventional pumps.

The research work was carried out on slurries of coarse iron ore particles and non-Newtonian fluids.

The terms “non-Newtonian fluid” and “coarse iron ore particles” were understood in the research work to mean:
Non-Newtonian fluid: A fluid in which iron ore particles are transported. Fluids may be a simple fluid like water or a more complex fluid, for example, a slurry composed of water and ultra-fine particles or slimes that are intimately held together by interparticle forces and form a non-Newtonian fluid.
Coarse iron ore particles: These are iron ore particles that were too large and too massive to form a part of the non-Newtonian fluid.

The research work was carried out on coarse iron ore that comprised minus 10 mm particles, with at least 80% by weight of the ore particles being greater than 0.01 mm in diameter. The iron ore was from mines of the applicant in the Pilbara region of Western Australia.

The research work was carried out on the following non-Newtonian fluid options:

Non-Newtonian fluid options

Autogenous ore and water
Shales and water
Operations tailings
Commercial clay and water

The above non-Newtonian fluid options comprised ultra-fine particles and slimes in aqueous liquids. At sufficiently high concentrations the ultra-fine particles combined with the underlying aqueous liquids and formed non-Newtonian fluids. These fluids then became transporting media for the coarse ore particles.

Shear yield stress is a rheological parameter that represents a minimum shear stress (force) required to cause a mineral slurry to deform and/or flow. The shear yield stress is the point at which an internal structure (e.g. a flocculated mineral slurry network, or particle-particle bonds) are broken down sufficiently to allow flow to commence. Below the shear yield stress, the material responds like an elastic solid. Above the shear yield stress, the material flows like a viscous fluid.

The minimum shear yield stress required to support a mineral particle having a diameter (d)(mm) is a function of the particle shape factor (k≅0.1 for ore particles), the gravity constant (g), the solids density (pₛ) and the slurry density (p_{c}):

τ_{y}=kgd(pₛ−p_{c})

Typically, the minimum shear yield stress τ_{y} required to support iron ore particles is in a range of 20-40 Pa in a case of slurries formed from coarse iron ore particles having a top size of 70 mm and a non-Newtonian fluid comprising ultrafine particles of iron ore in water, with the iron ore having a specific gravity in a range of 4-4.3, the solids concentration in the non-Newtonian fluid being in a range of 10-60% by volume, and the coarse ore particles being 20-40% by volume of the slurry.

The experimental work considered the following two scenarios:
Where solids other than the ore are used in the non-Newtonian fluid to transport the ore.
Where the ore particle size distribution is modified so that only ore particles are used to form the non-Newtonian fluid and are transported by the fluid.

The former case describes a situation where the non-Newtonian fluid is more easily produced using locally found shales and clays, or other additives. These materials do not have any economic value and would generally be considered a contaminant. Hence, it may be necessary to remove the non-Newtonian fluid from the ore at the end of the pipeline.

The second case is a situation where a sufficient quantity of ultra fine ore particles exists or can be produced to achieve the necessary rheological properties of the non-Newtonian fluid. In this instance, all of the particles transported have economic value. Hence, the slurry would be dewatered at the end of the pipeline with coarse ore and shipped to the customer.

The research work was carried out under a range of flow regimes.

As indicated above, the research work included investigating whether coarse ore particles could be pumped to the surface of a mine pit in the non-Newtonian fluids using conventional pumps. The parameters for the pumping analysis are as follows: a standard commercial centrifugal pump, a slurry of coarse iron ore particles with a 70 mm topsize and operations tailings as the non-Newtonian fluid, a coarse ore particle concentration of 30% by volume, a 700 mm internal diameter pipeline at angles of 50° and 60° and a vertical uplift height of 300 m. It was found that the coarse ore particles could be pumped under the above conditions.

The research work showed that:
Coarse iron ore particles could be transported 50 km, or further, using a non-Newtonian fluid in pipelines using positive displacement pumps.
Coarse iron ore particles (top size of 70 mm) could be pumped at least 300 m vertically in a 50° and 60° inclined pipelines using commercial centrifugal pumps.
The non-Newtonian pumping system was insensitive to coarser particle size in that minus 10 mm particles and minus 6.3 mm particles produced the same pressure drop.
Pressure gradients for transporting minus 10 mm ore particles using a non-Newtonian fluid were comparable to those obtained transporting minus 1 mm particles in water.
The non-Newtonian system could operate at low pipeline velocities (<2 m/s) and hence there would be less pipeline wear.
The shear yield stress of the non-Newtonian fluid makes it possible to stop and re-start flow in a pipeline with relative ease.
The operations tailings and shale were suitable options for the non-Newtonian fluid in that they produced low pressure gradient and energy consumption. This is important because these are low cost options.
A range of flow regimes were successful—it was found that the coarse ore particles were transported as a sliding bed.
The non-Newtonian fluid should contain a sufficient quantity of ultra-fine particles to have a shear yield stress that is sufficient to suspend the coarsest particle under static conditions.
The non-Newtonian fluid should exhibit shear thinning behaviour with little or no thixotropy, not significantly degrade when repeatedly sheared, be non-segregating during pumping or storage, be easily separated from the ore at the correct time and/or place, be non-corrosive to the pumping system or pose potential additional environment issues should a spillage occur, be non-corrosive to the pumping system or pose potential additional environment issues should a spillage occur, not degrade the ore quantity or downstream processing steps should a residual quantity remain on the coarse ore particles.

Many modifications may be made to the present invention as described above without departing from the spirit and scope of the invention.

By way of example, whilst the embodiment and the invention generally is described above in the context of mined material in the form of mined iron ore, the present invention is not so limited and extends to other types of mined material, such as base and precious metals and bauxite. In addition, the present invention extends to mined material that may be regarded as “waste” in a mining operation.

By way of further example, whilst the embodiment includes the use of a non-Newtonian fluid in the form of mine tailings of the same ore as the coarse ore to be pumped that has been thickened with additional ultrafine ore particles to form the non-Newtonian fluid, the present invention is not so limited and extends to any suitable non-Newtonian fluid.

1-31. (canceled)

32. A method of pumping a mined material in the form of a coarse ore that comprises:
(a) suspending particles of the coarse ore in a non-Newtonian fluid and thereby forming a slurry of the coarse ore particles in the fluid, and
(b) transferring the slurry, for example by pumping the slurry, in a pipeline.

33. The method defined in claim 32, wherein the coarse ore has particle sizes greater than 1 mm.

34. The method defined in claim 32, wherein the coarse ore has particle sizes greater than 6 mm.

35. The method defined in claim 32, wherein a shear yield stress of the non-Newtonian fluid is sufficient to suspend the largest particles in the coarse ore particles in the non-Newtonian fluid.

36. The method defined in claim 32, wherein the non-Newtonian fluid comprises a slurry of ultra-fine particles or slimes in water.

37. The method defined in claim 36, wherein the ultra-fine particles have particle sizes below 0.5 mm.

38. The method defined claim 32, comprising mining ore in a mine, primary crushing the mined ore in a mine pit, secondary and optionally tertiary crushing the primary crushed ore and thereby forming the coarse ore particles in the mine pit, and forming the slurry from the coarse ore particles in the mine pit.

39. The method defined in claim 38, comprising pumping the slurry from the mine pit up a pit wall.

40. The method defined in claim 39, wherein the pit wall is at least 30-50 m high.

41. The method defined in claim 38, comprising pumping the slurry to a wet upgrading plant and separating the coarse ore particles from the non-Newtonian fluid.

42. The method defined in claim 41, comprising using the separated non-Newtonian fluid in step (a) and forming the slurry.

43. The method defined in claim 32, wherein step (a) comprises forming the slurry with a concentration of at least 30% by volume coarse ore particles.

44. The method defined in claim 32, wherein step (b) comprises transferring the slurry at a velocity of less than 5 m/s.

45. The method defined in claim 32, wherein the coarse ore has a specific gravity of greater than 1.2.

46. An apparatus for pumping a mined material in the form of a coarse ore that comprises:
(a) a plant for forming a slurry of coarse ore particles and a non-Newtonian fluid;
(b) a pipeline for transporting the slurry from the slurry plant; and
(c) at least one pump for pumping the slurry along the pipeline.

47. The apparatus defined in claim 46, wherein the slurry plant is located in a mine pit.

48. The apparatus defined in claim 46, wherein the pit wall is at least 30-50 m high.

49. The apparatus defined in claim 46, wherein the pit wall has an angle of inclination of at least 30° to a horizontal axis.

50. A method of pumping a mined material in the form of a coarse ore that comprises:
(a) suspending particles of the coarse ore having particle sizes greater than 6 mm in a non-Newtonian fluid comprising a slurry of ultra-fine particles or slimes in water and thereby forming a slurry of the coarse ore particles in the non-Newtonian fluid, and
(b) transferring the slurry in a pipeline.

51. A method of pumping a mined material in the form of particles of a coarse ore that comprises:
(a) mining ore in a mine,
(b) primary crushing the mined ore in a mine pit,
(c) secondary crushing the primary crushed ore and thereby forming the coarse ore particles in the mine pit,
(d) suspending the coarse ore particles in a non-Newtonian fluid and thereby forming a slurry of the coarse ore particles in the non-Newtonian fluid in the mine pit, and
(e) transferring the slurry in a pipeline.
